(19) United States
(12) Patent Application Publication
(10) Pub. No.: US 2004/0019664 A1
(43) Pub. Date: Jan. 29, 2004

(54) Method and system for discovering a network element in a network such as an agent in an IP network

(76) Inventors: Franck Le, Irving, TX (US); Stefano M. Faccin, Dallas, TX (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/365,650

(22) Filed: Feb. 13, 2003

Related U.S. Application Data
(60) Provisional application No. 60/357,403, filed on Feb. 15, 2002.

(51) Int. Cl. G06F 15/177

(52) U.S. Cl. 709/220

(57) ABSTRACT

A method for discovering an agent in an IP environment comprising broadcasting router advertisement messages by router, wherein the messages comprise a first data element corresponding to a network prefix which identifies the network visited by a communication device; receiving the messages by the communication device; obtaining, by the communication device, a second data element identifying the agent; and computing an IP address of the agent by the communication device by using the first data element and the second data element.

The present application claims the benefit of U.S. Provisional patent application No. 60/357,403 filed on Feb. 15, 2002, the contents of which is herein incorporated by reference in its entirety.

### BACKGROUND OF THE INVENTION

1. Field of the Invention

The present invention relates to networks, and more specifically to the discovery of a network element in a network such as an agent in an Internet Protocol (IP) environment.

2. Description of the Related Art

In many protocols defined by the Internet Engineering Task Force (IETF), there is a need for a host device to discover an agent in the network. As an example, in IP paging the host device needs to discover the address of a paging agent in order to perform paging registration, paging area update, and the other paging procedures. The host device uses router advertisements to get from the network the relevant information needed to obtain connectivity with the network. There are some applications that require interaction with an agent in order to obtain connectivity. However, to initiate interactions with an agent the host needs to know the address of such agent, i.e., the host needs to discover the agent. Currently various discovery mechanisms exist such as the Service Location Protocol (SLP), the Domain Name Server (DNS), the Dynamic Host Configuration Protocol (DHCP), the Lightweight Directory Access Protocol (LDAP), etc., but they all require the host to interact first with an entity in the network, e.g., SLP server or DNS server, to discover the agent and retrieve its address.

Although it is feasible that any access router broadcasts, i.e., advertises, in the router advertisement the address of the agent to be used by the host connecting through that default router, this would require adding a 128 bits IPv6 address or 32 bits IPv4 address to the router advertisement for each agent to be advertised. This impacts considerably the access link, given that router advertisements may have to be sent as frequently as every 500 ms and thus broadcasting the addresses adds an overhead of 2(128 times the number of agents) bits per second (i.e., 32 bytes/s) for IPv6 and 2(32 times the number of agents) bits per second (i.e., 8 bytes/s) for IPv4. Moreover, several agents may be advertised e.g., for reliability purposes, impacting the access link even more.

At the IETF, the working group entrusted with the Protocol for carrying Authentication for Network Access (PANA) has also identified this need for agent discovery, i.e., that the user first needs to discover the PANA agent to know where to send its credential.

Thus, a proposed solution would be to advertise the IP address of the agent in the router advertisement, but the IPv6 addresses are long and several IP addresses may need to be advertised (PANA agent one, Paging Agent one, etc.) This may therefore not be acceptable, since it requires a longer router advertisement, which in particular is an issue for cellular networks.

Another proposed solution would be to use the anycast address, i.e., the mobile node uses a well-known anycast address to send messages to a given agent (e.g., the one required by PANA). However, the security of anycast is not completely specified and there are known security issues.

Other proposals based on the anycast addresses exist which have less security issues and suggest to only send a request to the anycast address that leads either to the agent or to a server, where the server will then respond by giving the IP address of the agent whereas the agent will return its own address, but this procedure requires a request/response exchange which may also induce more delay.

In addition, the following issues have already been discussed in this connection.

RFC 2461 of the IETF specifies that a router advertisement contains network prefix information.

RFC 2462 of the IETF makes use thereof and discloses an address autoconfiguration technique, where upon receiving a router advertisement containing such a network prefix information according to RFC 2461, an identifier is generated by a mobile node and appended with the prefix information to obtain an IP address.

The above-mentioned references are exemplary only and are not meant to be limiting in respect to the resources and/or technologies available to those skilled in the art.

### SUMMARY OF THE INVENTION

Therefore, it is an object of the present invention to overcome the shortcomings described above, and to provide a method and system for discovering an agent in an IP environment.

The present invention is a method of discovering a first network element in a network comprising broadcasting by a second network element advertisement messages, wherein the messages comprise a first data element; receiving the messages by a communication device; obtaining, by the communication device, a second data element; and computing an address of the first network element by the communication device by using the first data element and the second data element.

In the method according to the present invention, the first network element can be an agent, and the network can be an IP network. In addition, the second network element can be a router, and the advertisement messages can be router advertisement messages.

Regarding the data elements, the first data element may correspond to a network prefix which identifies the network visited by a communication device, and the second data element may identify the second network element of a network visited by the communication device, wherein the second network element can be an agent.

Still further, the first network element can be an IP address.

The present invention is also a system for discovering a first network element in a network comprising a second network element for broadcasting advertisement messages, wherein the messages comprise a first data element; a communication device for receiving the messages, for obtaining a second data element, and for computing an address of the first network element by using the first data element and the second data element.

Here, the same further definitions as above can apply.

It can be an advantage of the present invention that any request/response exchange to discover the address of the first network element which can be an agent is not required. Further, the security issues being present in other proposals (e.g., anycast address) do not apply to the solutions according to the present invention.

One aspect of the present invention is a method of discovering an agent in an IP environment, wherein the agent is of a certain type out of a predetermined group of types and the method comprises: broadcasting router advertisement messages by access router, wherein such messages include a network prefix; receiving the messages by a communication device; gaining a suffix identifying the agent from a data element list stored in the communication device, wherein each suffix corresponds to a specific one of the group of types; and computing an IP address by the communication device by using the network prefix and suffix.

This aspect is also a system for discovering an agent in an IP environment, wherein the agent is identified in its network by a suffix and comprises a certain type out of a predetermined group of types, and the network which corresponds to the agent is identified by a prefix, the system comprising: an access router for broadcasting router advertisements comprising the prefix; and a communication device for gaining the suffix from a suffix list stored in it, for receiving router advertisements, and for computing an IP address using the prefix and the suffix, wherein the suffix corresponds to a specific one of the group of agent types.

In the method and system according to this aspect, the computed IP address can correspond to a destination IP address of the agent which is replaced by the actual IP address of the agent by the access router when packets are sent from the communication device to the discovered agent, thereby routing the packets by the access router to the agent.

As an alternative, if the computed IP address corresponds to a destination IP address of the agent, packets sent from the communication device to the discovered agent can be tunneled by the access router to the actual IP address of the agent.

In addition, the IP address of the agent can be computed by using the suffix and completing the IP address by adding the high order network prefix bits.

It is an advantage according to this aspect of the present invention that any modification to the router advertisements is not required and that the number of information that needs to be broadcast is not increased, since the suffix does not need to be advertised.

Another aspect of the present invention is a method of discovering an agent in an IP environment comprising: broadcasting router advertisement messages by access router, wherein such messages includes a network prefix and a suffix identifying the agent in its network; receiving the messages by a communication device; and computing the IP address of the agent by the communication device by combining the network prefix and the suffix.

This aspect is also a system for discovering an agent in an IP environment, the agent in its network being identified by a suffix, the system comprising: an access router for broadcasting router advertisements comprising a network prefix and a suffix identifying the agent in the network; and a communication device for receiving router advertisements, for identifying the prefix, and for computing the IP address of the agent by combining the prefix and the suffix.

In the method and system according to this second aspect, the computed IP address can correspond to the actual IP address of the agent so that packets sent from the communication device to the discovered agent are routed by the access router to the agent.

In addition, the router advertisement messages can be extended by adding each of a first field identifying the agent type, a second field indicating the length of the suffix, and a third field containing the suffix.

The IP address of the agent can be computed by using the suffix and completing the IP address by adding the high order network prefix bits.

It is an advantage of the second aspect according to the present invention that it is not required that any agent identifier is to be defined in standardization.

### BRIEF DESCRIPTION OF THE DRAWINGS

FIG. 1 shows an example of an IP system for explaining the embodiments according to the present invention; and

FIG. 2 shows a process according to an example embodiment of the present invention.

### DETAILED DESCRIPTION OF THE PREFERRED EMBODIMENTS

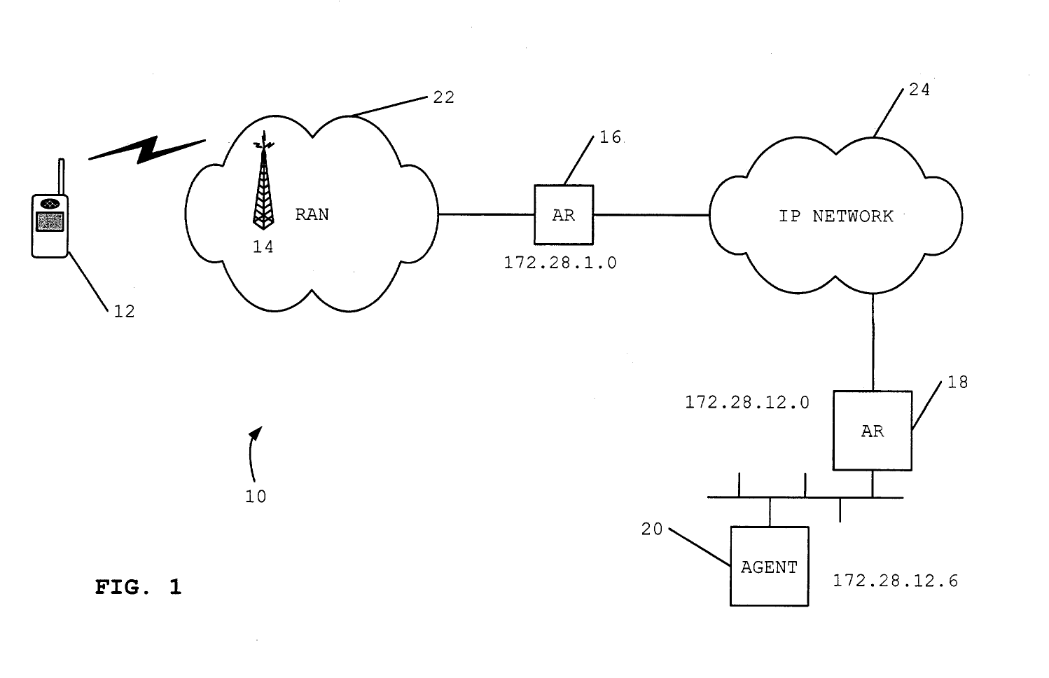

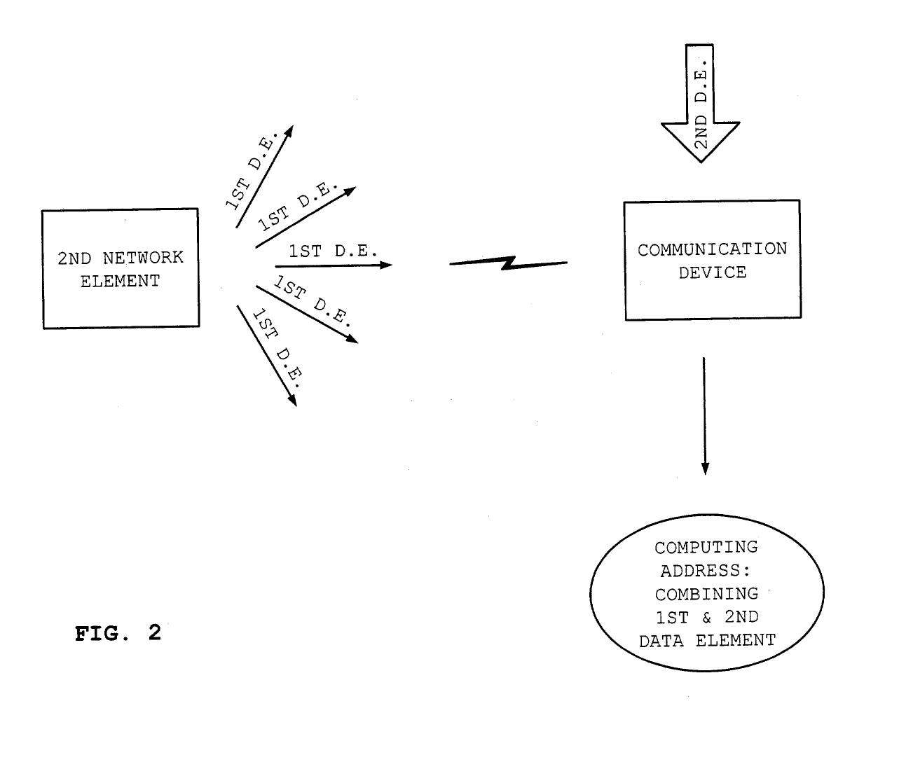

FIG. 2 shows a process according to an example embodiment of the present invention, while FIG. 1 reflects a particular example thereof. It is however to be understood that also only particular elements of the example shown in FIG. 1 may apply to the method and system of the present invention. That is, what is shown in FIG. 2 is a method and system of discovering a first network element in a network comprising broadcasting by a second network element advertisement messages, wherein the messages comprise a first data element (1^{st} d. e.); receiving the messages by a communication device; obtaining, by the communication device, a second data element (2^{nd} d. e.); and computing an address of the first network element by the communication device by using the first data element and the second data element.

Moreover, the present invention is generally applicable to IP environments, i.e., including mobile IP environments. That is, while the following description of the preferred embodiments illustrates the present invention by referring to a mobile IP example, it is to be understood that the present invention is not limited thereto, but can be applied to any IP environments.

When a mobile node enters a new sub-network, it needs to get some information related to the sub-network that are needed to obtain connectivity. The router advertisement sent by access router (AR) currently broadcast the network prefix(es) to be used for the creation of a care-of-address in the access router sub-network besides other information needed for the mobile nodes to get connectivity.

If mechanisms such as IP Paging or such as PANA are adopted, the mobile node may need to send messages to an entity in the network that is not known a priori to the mobile node.

In the following, the preferred embodiments of the present invention comprising a method and system for discovering an agent are described.

In particular, presently, there are considered two ways of implementing the present invention to be preferable.

In a first embodiment of the present invention, a certain type of an agent of an IP network has a standardized identifier referred to as a suffix, and the suffix of the agent may be stored to the memory of a host (e.g., mobile node). The suffix when combined with the network prefix advertised by the access router forms a full IP address either identifying the agent in the IP network or identifying an IP address that can be used by the access router to route data to the agent. Therefore, if the mobile node wishes to interact with the agent, an access router of the network is only required to broadcast the network prefix.

Specifically, according to the first embodiment, it is assumed that a commonly agreed set of identifiers is defined by e.g., the IETF (or 3 GPP), wherein each suffix is associated to a particular type of agent (e.g., “00 . . . 01” is for PANA, “00 . . . 02” is for IP Paging, etc.). The mobile node uses the commonly agreed identifier for a given agent as suffix for the IP address of the agent. The prefix for the address is the (or one of) prefix(es) the access router broadcasts in the router advertisement.

When the access router receives a packet destined to the address of the agent (the access router knows what are the addresses that mobile nodes can use to initially address the agent), there are two possible cases:

If the agent is on a link of the access router, the address used by the mobile node can be the actual IP address of the agent, thus the access router simply routes the packet to the agent.

If instead the agent is not physically connected to one of the access router links, the access router either replaces the destination IP address used by the mobile node with the actual IP address of the agent, or the access router tunnels the packet to the actual IP address of the agent.

Both solutions are feasible, the second one has less security issues, since if the mobile node authenticated the packet using the IP Security Protocol (IPsec, i.e., the Authentication Header, AH), the agent can verify the validity of the packet, since the header of the packet is not modified. The agent and the packet can then continue with the message exchange according to the specific protocol (e.g., PANA, IP Paging, etc.).

The IP address of the agent can either be manually configured in the access router or discovered through different mechanisms such as SLP according to RFC 2608. Further, the IP address can be a unicast or an anycast one. The anycast one will e.g., allow a more efficient load sharing between the agents.

It is most probable that agents will not be placed on a link of the access router. In fact, this implies that there is one agent of a given type (e.g., PANA) for each access router, whereas there would be more flexibility in the way the network is build (e.g., one agent for a set of access router).

For implementing the first embodiment according to the present invention, no modification to the router advertisement are required, but only one entry in the access router routing table to tunnel the packets to the appropriate agent.

In a second embodiment of the present invention, the router broadcasts router advertisements comprising the network prefix, and a part of the IP address of an agent, referred to as a suffix. The suffix, when combined with the network prefix provides the full IP address of the agent identifying the agent in the IP network. Upon receipt of the router advertisement, the mobile node identifies the suffix and combines it with the network prefix to provide the full IP address of the agent.

Specifically, according to the second embodiment, the mobile node uses the identifier received as content thereof in the router advertisement as suffix for the IP address of the agent. The most significant bits (MSBs) of the address are derived from the (or one of) prefix(es) the access router broadcasts in the router advertisement. If the bits of the prefix and the suffix are overlapping, the user must take the suffix ones. As an example (using IPv4), if the advertised network prefix is 172.28, and the advertised suffix is 30.75.36, the user will get the IP address of the agent as 172.30.75.36. The same applies for IPv6.

The value of the identifier is configured in the access router by the network according to the selection of which agent is serving mobile nodes in the sub-network of the access router. In order to allow for the agent to be located in the network elsewhere than one of the access router links (and thus to have one agent serving the mobile nodes in multiple access router), the identifier is set to a value that allows the mobile node to take the prefix advertised by the access router (e.g., 172.28) and the identifier (e.g., 30.75.36) and create the agent IP address (in the example 172.30.75.36) that is not on one of the links of the access router but still in the same network of the access router.

Since the address created by the mobile node is the actual IP address of the agent, when the access router receives a packet destined to the address of the agent, the access router simply routes the packet to the destination address.

The second embodiment can be implemented by effecting only some extensions to the router advertisements messages. A first field would identify the agent such as an IP paging agent, a PANA agent, etc., a second field would indicate the length of the suffix, and a third field would contain the suffix.

Hereinafter, reference is made to FIG. 1 showing an example of a wireless IP system for explaining the preferred embodiments of the present invention.

The IP system is denoted generally 10. As example for explaining the preferred embodiments of the present invention is illustrated a wireless IP system, but the present invention can be applied to all IP systems where improving the efficiency and latency of a network link can be realized by using the techniques described herein. In FIG. 1, the wireless IP system 10 comprises a mobile node 12, a base transceiver station (BTS) 14, an access router (AR) 16,18, and an agent 20. The BTS 14 may be communicable coupled to the mobile node 12 for transmitting and receiving RF signals over a radio link having an access frequency dependent on the type of wireless IP system. The access router 16 may be coupled to BTS 14 through a radio access network 22 having elements specific for radio access systems and to the access router 18 and the agent 20 through an IP network 24.

According to the first embodiment of the present invention, in the example shown by FIG. 1, agent 20 has an IP address, for example 172.28.12.6, and a standardized identifier, referred to as a suffix, that may be, for example, 11.11. The mobile node 12 may have the suffix stored in its memory. The access router 16 frequently broadcasts router advertisements that can be used by the mobile node 12 to learn the network prefix within the IP network 24. The mobile node 12 needing to discover the agent 20 uses the router advertisements to learn the network prefix, for example 172.28.1.0, as shown in FIG. 1. Therefore, upon receiving the router advertisement, the mobile node 12 simply takes the suffix and completes the missing bits from the network prefix received in the router advertisement messages to obtain the IP address of the agent on the IP network, 172.28.11.11, and sends the requests to the agent to this IP address. The access router will tunnel the packet destined to 172.28.11.11 to the real IP address of the agent 172.28.12.6.

In turn, according to the second embodiment of the present invention regarding the example presented in FIG. 1, the access router 16 broadcasts router advertisements comprising the IP address of the router and the suffix of the IP address of the agent 20. Therefore, there is no need for a standardized IP address for each type of agent. For example, the agent 20 may be a node having an IP address of 172.28.12.6 and the access router 18 advertises the network prefix 172.28.1.0. Hence, the access router 16 would only be required to broadcast the network prefix 172.28.1.0 and a small suffix 12.6. The mobile node 12 would derive the full IP address of the agent 20 from this information, for example 172.28.12.6.

What is described above is a method of discovering an agent in an IP environment comprising broadcasting router advertisement messages by router, wherein the messages comprise a first data element corresponding to a network prefix which identifies the network visited by a communication device; receiving the messages by the communication device; obtaining, by the communication device, a second data element identifying the agent; and computing an IP address of the agent by the communication device by using the first data element and the second data element.

Thus, while the invention has been particularly shown and described with respect to one or more preferred embodiments thereof, it will be understood by those skilled in the art that certain modifications or changes, in form and shape, may be made therein without departing from the scope and spirit of the invention as set forth above and claimed hereafter.

What is claimed is:

1. A method of discovering a first network element in a network comprising:
broadcasting by a second network element advertisement messages, wherein the messages comprise a first data element;
receiving the messages by a communication device;
obtaining, by the communication device, a second data element; and
computing an address of the first network element by the communication device by using the first data element and the second data element.

2. The method according to claim 1, wherein the first network element is an agent.

3. The method according to claim 1, wherein the network is an IP network.

4. The method according to claim 1, wherein the second network element is a router.

5. The method according to claim 2, wherein the second network element is a router.

6. The method according to claim 4, wherein the advertisement messages are router advertisement messages.

7. The method according to claim 5, wherein the advertisement messages are router advertisement messages.

8. The method according to claim 1, wherein the first data element corresponds to a network prefix which identifies the network visited by a communication device.

9. The method according to claim 2, wherein the first data element corresponds to a network prefix which identifies the network visited by a communication device.

10. The method according to claim 1, wherein the second data element identifies the second network element of a network visited by the communication device.

11. The method according to claim 2, wherein the second data element identifies the agent of a network visited by the communication device.

12. The method according to claim 1, wherein the second data element identifies the first network element.

13. The method according to claim 2, wherein the second data element identifies the agent.

14. The method according to claim 1, wherein the address of the first network element is an IP address.

15. The method according to claim 2, wherein the address of the first network element is an IP address.

16. A system for discovering a first network element in a network comprising:
a second network element for broadcasting advertisement messages, wherein the messages comprise a first data element;
a communication device for receiving the messages, for obtaining a second data element, and for computing an address of the first network element by using the first data element and the second data element.

17. The system according to claim 16, wherein the first network element is an agent.

18. The system according to claim 16, wherein the network is an IP network.

19. The system according to claim 16, wherein the second network element is a router.

20. The system according to claim 17, wherein the second network element is a router.

21. The system according to claim 19, wherein the advertisement messages are router advertisement messages.

22. The system according to claim 20, wherein the advertisement messages are router advertisement messages.

23. The system according to claim 16, wherein the first data element corresponds to a network prefix which identifies the network visited by the communication device.

24. The system according to claim 17, wherein the first data element corresponds to a network prefix which identifies the network visited by the communication device.

25. The system according to claim 16, wherein the second data element identifies the second network element of a network visited by the communication device.

26. The system according to claim 17, wherein the second data element identifies the agent of a network visited by the communication device.

27. The system according to claim 16, wherein the second data element identifies the first network element.

28. The system according to claim 17, wherein the second data element identifies the agent.

29. The system according to claim 16, wherein the address of the first network element is an IP address.

30. The system according to claim 17, wherein the address of the first network element is an IP address.

31. A method of discovering an agent in an IP environment, wherein the agent is of a certain type out of a predetermined group of types and the method comprises:
broadcasting router advertisement messages by access router, wherein such messages include a network prefix;
receiving the messages by a communication device;
gaining a suffix identifying the agent from a data element list stored in the communication device, wherein each suffix corresponds to a specific one of the group of types; and
computing an IP address by the communication device by using the prefix and suffix.

32. The method according to claim 31, wherein the computed IP address corresponds to a destination IP address of the agent which is replaced by the actual IP address of the agent by the access router when packets are sent from the communication device to the discovered agent, thereby routing the packets by the access router to the agent.

33. The method according to claim 31, wherein the computed IP address corresponds to a destination IP address of the agent and packets sent from the communication device to the discovered agent are tunneled by the access router to the actual IP address of the agent.

34. The method according to claim 31, wherein the IP address of the agent is computed by using the suffix and completing the IP address by adding the high order network prefix bits.

35. A system for discovering an agent in an IP environment, wherein the agent is identified in its network by a suffix and comprises a certain type out of a predetermined group of types, and the network which corresponds to the agent is identified by a prefix, the system comprising:
an access router for broadcasting router advertisements comprising the prefix; and
a communication device for gaining the suffix from a suffix list stored in it, for receiving router advertisements, and for computing an IP address using the prefix and the suffix, wherein the suffix corresponds to a specific one of the group of agent types.

36. The system according to claim 35, wherein the computed IP address corresponds to a destination IP address of the agent, and the access router replaces the destination IP address by the actual IP address of the agent when packets are sent from the communication device to the discovered agent.

37. The system according to claim 35, wherein the computed IP address corresponds to a destination IP address of the agent, and the access router tunnels packets sent from the communication device to the discovered agent to the actual IP address of the agent.

38. The system according to claim 35, wherein the computed IP address of the agent consists of the suffix when completed by adding the high order network prefix bits.

39. A method of discovering an agent in an IP environment comprising:
broadcasting router advertisement messages by access router, wherein such messages include a network prefix and a suffix identifying the agent in its network;
receiving the messages by a communication device; and
computing the IP address of the agent by the communication device by combining the prefix and the suffix.

40. The method according to claim 39, wherein the computed IP address corresponds to the actual IP address of the agent so that packets sent from the communication device to the discovered agent are routed by the access router to the agent.

41. The method according to claim 39, wherein the router advertisement messages are extended by adding each of a first field identifying the agent type, a second field indicating the length of the suffix, and a third field containing the suffix.

42. The method according to claim 39, wherein the IP address of the agent is computed by using the suffix and completing the IP address by adding the high order network prefix bits.

43. A system for discovering an agent in an IP environment, the agent in its network being identified by a suffix, the system comprising:
an access router for broadcasting router advertisements comprising a network prefix and a suffix identifying the agent in the network; and
a communication device for receiving router advertisements, for identifying the prefix, and for computing the IP address of the agent by combining the prefix and the suffix.

44. The system according to claim 43, wherein the computed IP address corresponds to the actual IP address of the agent and the access router routes packets sent from the communication device to the discovered agent.

45. The system according to claim 43, wherein the computed IP address of the agent consists of the suffix when completed by adding the high order network prefix bits.
